(19) United States
(12) Patent Application Publication
(10) Pub. No.: US 2026/0067168 A1
(43) Pub. Date: Mar. 5, 2026

(54) GENERATING SERVICE STACK MAPS FOR MICROSERVICE-BASED APPLICATIONS

(71) Applicant: HEWLETT PACKARD ENTERPRISE DEVELOPMENT LP, Spring, TX (US)

(72) Inventors: Suresh Vobbilisetty, San Jose, CA (US); Phanidhar Koganti, Frisco, TX (US); Elaine Ping Ping Tang, San Jose, CA (US); Ramanagopal Vogety, San Jose, CA (US); Erkin Beishenov, San Jose, CA (US)

(21) Appl. No.: 18/823,445

(22) Filed: Sep. 3, 2024

(51) Int. Cl. H04L 41/122; H04L 41/0631

(52) U.S. Cl. CPC H04L 41/122; H04L 41/0631

(57) ABSTRACT

A map generation engine receives data from collector agents located in a container environment layer, a virtualized infrastructure and a physical infrastructure of a service stack of a microservice-based application. The microservices of the application may be deployed on a distributed system. The map generation engine, based on the interdependencies, generates data representing a map of the service stack. The map represents the interdependencies, which allows an issue associated with the application services, the virtualized infrastructure or the physical infrastructure to be traced via the map to identify a root cause of the issue.

### BACKGROUND

A business enterprise may rely on any of a number of different computing environments to provide its services. In examples, the computing environments for a particular business enterprise may be confined to a private cloud (e.g., an on-premise datacenter), confined to a public cloud, or be a mixture of public and private clouds. A business enterprise may subscribe to an information technology (IT) operations management (ITOM) platform (e.g., a public cloud-based, software-as-a-service (SaaS) platform) for such purposes as monitoring service availabilities; and detecting, predicting and remediating service issues.

### BRIEF DESCRIPTION OF THE DRAWINGS

FIG. 1 is a block diagram of a computer network that includes an operations management platform that provides a mapping service to generate graphical user interface (GUI)-based service stack maps for microservice-based applications, according to an example implementation.

FIG. 2 is a block diagram of a full-service stack of a microservice-based application according to an example implementation.

FIGS. 3 and 4 depict GUI-based service stack maps according to example implementations.

FIG. 5 is a sequence flow diagram depicting the collection of data representing interlayer dependencies of a microservice-based application and the construction of data representing a GUI-based map of the application's service stack according to an example implementation.

FIG. 6 is a block diagram of a system to generate data representing a service stack map of a microservice-based application according to an example implementation.

FIG. 7 an illustration of instructions stored on a non-transitory system-readable storage medium, which when executed by a hardware processor of an IT operations management system, cause the IT operations management system to generate data representing a service stack map of a microservice-based application according to an example implementation.

FIG. 8 is a flow diagram depicting a technique to generate data representing a service stack map of a microservice-based application according to an example implementation.

### DETAILED DESCRIPTION

In one type of application architecture, an application may be monolithic and correspond to a single unit. In another type of application architecture, an application may be formed from multiple, autonomous parts called “microservices.” As compared to the monolithic architecture, the microservice architecture provides greater agility, elasticity and greater control for software quality assurance.

The microservices of an application may be deployed on a distributed system. The structure of the application may be represented by a layered hierarchy referred to as a “service stack” and is referred to as the “full-service stack” when referring to the entire hierarchy. The uppermost layer (called the “workload layer” herein) of the full-service stack corresponds to the application's workflow, which is the arrangement of workloads to achieve the particular goals, or results, of the application. In this context, a “workload” (or “computer-based workload”) refers to a collection of one or multiple application processes. In an example, a workload may correspond to an instance of a microservice. A workload may be associated with any of a number of different application classifications, or types. In examples, a given workload may perform processing related to data analytics (DA), high performance computing (HPC) or artificial intelligence (AI). In other examples, workloads may be associated with business enterprise applications, event-driven applications, graphics processing, as well as other applications that address other needs. Moreover, a given workflow may include a combination of workloads that correspond to different application categories, or types. For example, a workflow may include one or multiple DA-related workloads to identify patterns and correlations in a voluminous dataset, and these patterns and correlations may serve as features that are processed by one or multiple AI-related workloads of the workflow. In another example, a workflow may include an AI-related workload that relies on one or multiple HPC-related workloads of the workflow to perform computationally-complex processing (e.g., processing related to parameter tuning or model estimation). Similarly, AI can be used for computational steering in HPC applications.

The workloads of a microservice-based application execute in a container environment resources layer, which is the next layer of the full-service stack below the workload layer. In this context, a “container environment resources layer” (or “container environment layer”) refers to a collection of one or multiple instantiated containers (also referred to herein as “containers”). For a container environment resources layer that includes multiple containers, the containers may collaborate for a particular purpose (e.g., providing a microservice). A container environment may be orchestrated or non-orchestrated (or “self-managed”). An orchestrated container environment has an orchestrator that manages the lifecycles and workloads of the environment's containers. In examples, an orchestrator may manage provisioning and resource allocation for the containers. In other examples, an orchestrator may manage container replication, when containers start and stop, container scaling, workload distribution among the containers, or other lifecycle phase or workload aspects of the container environment. In examples, an orchestrated container environment may have a KUBERNETES orchestrator or a DOCKER SWARM orchestrator. In an example, an orchestrated container environment may be a container cluster (e.g., a KUBERNETES cluster) having a control plane and worker nodes. In an example, a particular worker node may correspond to multiple container pods that, in turn, correspond to multiple instances of the same microservice.

Components of the container environment resources layer may be hosted by virtual machines (VMs) of a virtualization resources layer (or “virtualization layer”), which is the next layer of the full-service stack below the container environment resources layer. In an example, worker nodes of a container cluster may be hosted in respective VMs of the virtualization resources layer. In another example, a particular VM may host multiple worker nodes of a container cluster. The virtualization resources layer includes hypervisors that manage the VMs and abstract physical compute, storage and networking resources of an infrastructure resources layer (or “infrastructure layer”), which is the next layer of the full-service stack below the virtualization resources layer.

The infrastructure resources layer includes physical resources that support the application. In an example, the infrastructure resources layer includes central processing unit (CPU) cores that execute application code. In another example, the infrastructure resources layer includes graphics processing unit (GPU) cores that execute application code for relatively more computationally-intensive tasks, such as HPC tasks and AI-related tasks, such as machine learning model building and parameter tuning. In another example, the infrastructure resources layer includes buses (e.g., system buses, memory buses, CXL buses, and PCIe buses) that interconnect the physical CPU cores, GPU cores and memories. In other examples, the infrastructure resources layer includes networking and storage components. The hypervisors of the virtualization resources layer abstract the physical resources, and as such, the infrastructure resources layer may be associated with corresponding virtual resources for the VMs, such as virtual CPU cores, virtual GPU cores, virtual memory allocations, and so forth.

The complexities of a microservice-based application's service stack may be a barrier to troubleshooting issues, or problems, with the application. For example, there may be resource contention issues among resources of different microservices, and the resources may correspond to one or multiple layers of the service stack. Tracing a particular issue through the application's service stack to find the root cause of the issue may be a formidable task.

In accordance with example implementations that are described herein, a mapping service of an IT operations management platform generates graphical user interface (GUI)-based service stack maps for microservice-based applications. A GUI-based service stack map graphically represents the resources of various layers of an application service stack (e.g., a full-service stack or partial service stack), and the service stack map also represents interlayer dependencies among layers of the service stack. As described herein, a human user may use a GUI-based service stack map as a tool to trace an application issue through the service stack for purposes of identifying an issue's root cause. For example, a particular microservice may have an unacceptably low processing latency. Through the use of the GUI-based service stack map, a user may trace the low processing latency to its root cause, such as, for example, an inadequate virtual GPU core allocation for a VM that hosts container pods corresponding to instances of the microservice.

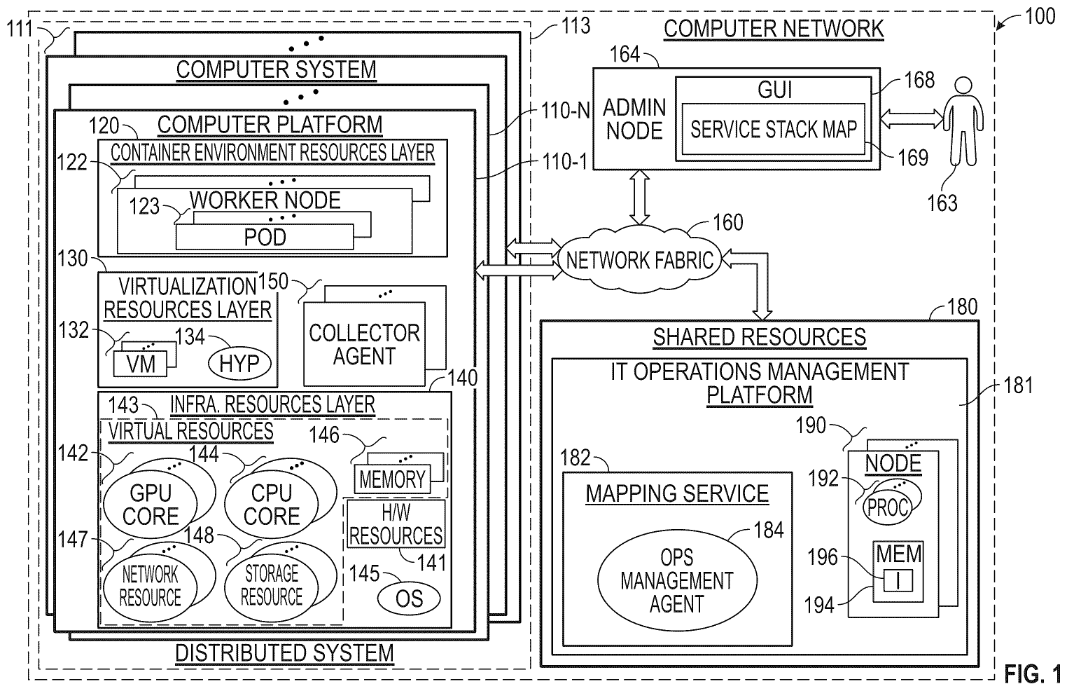

In a more specific example, FIG. 1 depicts a computer network 100 in accordance with some implementations. For the example implementations that are described herein, a microservice-based application is deployed on a distributed system 113 of the computer network 100. The distributed system 113 includes multiple computer systems 111. The computer systems 111 may be associated with multiple geographical locations, or sites, and the computer systems 111 are interconnected by network fabric 160. In accordance with example implementations, the network fabric 160 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

The computer systems 111, in accordance with example implementations, may be a collection of one or multiple non-cloud on-premise systems, private clouds, public clouds and/or hybrid clouds. In the context that is used herein, a “cloud” refers to a computer system that is associated with resources that can be scaled up and down on demand.

In an example, a particular computer system 111 corresponds to a private cloud that has on-premise resources that are located in a business entity's private datacenter or are located in a co-location datacenter and is managed by the business entity. In another example, a particular computer system 111 corresponds to a hybrid cloud that has on-premise resources (e.g., resources located in a private or co-location datacenter) that are managed by a public cloud operator. In another example, a particular computer system 111 corresponds to a public cloud. In another example, a particular computer system 111 corresponds to the network edge and provides connectivity for edge devices (e.g., client devices and sensors), as well as edge storage and edge compute services. More than one computer system 111 of the distributed system 113 may be located at the same geographical site.

A computer system 111 includes a collection of computer platforms 110. In this context, a “computer platform” refers to a unit that includes a chassis and hardware that is mounted to the chassis, where the hardware is capable of executing machine-executable instructions (or “software”). In examples, a computer platform 110 may be a server, such as an enclosure-based server (e.g., a blade server), a rack-based server (e.g., a density line server), or a tower server. In an example, a particular computer system 111 corresponds to a particular datacenter, and the computer platforms 110 correspond to servers of the datacenter. In another example, a particular computer system 111 corresponds to multiple datacenters and servers of the datacenters.

For the example implementation that is depicted in FIG. 1, a particular computer system 111 includes N computer platforms (represented in FIG. 1 by computer platforms 110-1 to 110-N). Example components of the computer platform 110-1 are depicted in FIG. 1 and described below. Other computer platforms of the computer system 111 may have similar components to the computer system 110-1 or may have different components and/or architectures, depending on the particular implementation. Moreover, the components of the computer platforms 110 and the architectures of the computer platforms 110 may vary among the computer systems 111, in accordance with some implementations. The architectures and specific resources of a particular computer system 111 accommodates the specific uses and workloads of the computer system 111. It is assumed in the following description that the computer platforms 110 of the distributed system 113 have similar components to the components of the computer platform 110-1, which are discussed herein.

Managing a microservice-based application so that all of the application's microservices perform as expected may be complicated by the application having microservices that either prominently use artificial intelligence or at least use artificial intelligence behind the scenes. In an example, an application may include a microservice to apply an embedding model to real world data to provide machine learning-compatible features, another microservice to apply machine learning-based inference based on the features and another microservice to tune parameters of a model used in the inference. In another example, an application may include a microservice to provide a virtual assistant to gather input data and another microservice to apply a machine learning-based model to the input data for purposes of performing Structured Query Language (SQL) coding for database accesses.

For such artificial intelligence-affiliated applications, it may be challenging to address issues with the application, as observability of the application across its full-service stack may be rather limited, especially when the microservices are distributed across multiple computer systems. In accordance with example implementations that are described herein, an information technology (IT) operations management platform 181 provides a mapping service 182 that generates graphical user interface (GUI)-based service stack maps 169 for microservice-based applications.

More specifically, in accordance with example implementations, the mapping service 182 gathers, or collects, data from collector agents 150 that are distributed across layers of the application's service stack. The data represents interlayer dependencies of the application's service stack. Based on the data that is provided by the collector agents 150, the mapping service 182 generates data for purposes of displaying a service stack map 169 on the GUI 168. User input controls of the GUI 168, in accordance with example implementations, control the various aspects of the displayed service stack map 169, such as, for example, whether the map 169 corresponds to the full-service stack map or partial service stack. The user input controls of the GUI 168 may also control, as another example, whether details about certain layers of the service stack are displayed. As described herein, the service stack map 169 may be manipulated and viewed by a human user 163 (called a “user 163” herein) via user controls of the GUI 168 for purposes of controlling service stack observability in a way that allows the user 163 to find underlying root causes of application issues (e.g., performance issues or other problems related to the application not behaving as expected).

The mapping service 182, in accordance with example implementations, is one of a suite of services (e.g., a collection of “as-a-Services,” such as a Software-as-a-Service (SaaS) collection of services) that are provided by the IT operations management platform 181. In an example, the IT operations management platform 181 is provided by resources 180 (called “shared resources 180” herein) of the computer network 100, which are shared by multiple tenants as part of a public cloud. The shared resources 180 are connected to the distributed system 113 and may be connected to other distributed systems (affiliated with the same customer or other customers) by the network fabric 160. In another example, the IT operations management platform 181 corresponds to a hybrid cloud. In another example, the IT operations management platform 181 corresponds to a private cloud. In another examples, the IT operations management platform 181 and the distributed system 113 are part of the same private cloud or part of the same hybrid cloud.

In accordance with example implementations, an operations management agent 184 of the IT operations management platform 181 is a mapping engine that provides the mapping service 182. A user 163 may, through the manipulation of graphical user controls (dropdown lists, buttons, text boxes, list boxes, radio buttons, slide buttons, buttons, checkboxes, text entry fields, sliders and other user interfaces) provide user input to configure options of the mapping service 182 and control how the service stack map 169 is presented on the GUI 168 for a particular application. The graphical user controls may be manipulated by the user 163 in any of a number of different ways, such as through mouse movements, mouse button clicks, trackpad gestures, touch screen gestures, keyboard input and input from other and/or different input devices. In an example, a user 163 may, through user input to the GUI 168, cause the GUI 168 to display a service stack map 169 that corresponds to the entire, or full, service stack map for a particular application. In another example, a user 163 may, through user input to the GUI 168, cause the GUI 168 to display a partial service stack map 169 for a particular application. In another example, a user 163 may, through user input to the GUI 168, configure the GUI 168 to show, for the service stack map 169, interconnections between microservice workloads and container pod groups and further show interconnections between the container pod groups and VMs on which the pod groups are deployed. In another example, a user 163 may, through user input to the GUI 168, configure the GUI 168 so that the service stack map 169 does not display infrastructure resources. In another example, a user 163, through user input to the GUI 168, causes the GUI 168 to display virtual resources (e.g., virtual GPU cores and/or virtual CPU cores) for the VMs.

In accordance with example implementations, the GUI 168 is provided by an administrative node 164 of the computer network 100. In an example, the administrative node 164 is a physical computer platform. In another example, the administrative node 164 is a VM that is hosted on a physical computer platform. In another example, the GUI 168 is browser-based, and the administrative node 164 is a client to a web server of the IT operations management platform 181. In an example, for purposes of interacting with the GUI 168, the client sends application programming interface (API) requests (e.g., representation state transfer (REST) API requests or gPRC requests) to uniform resource locator (URL) associated with the web server, and the web server responds with corresponding API responses.

The computer platform 110-1, similar to other computer platforms 110 of the distributed system 113, has various resource layers, which correspond to corresponding resource layers of the distributed system 113. The computer platform 110-1 includes a container environment resources layer 120 (or “container environment layer”) that is associated with one or multiple microservice instances. In accordance with example implementations, the container environment resources layer 120 corresponds to one or multiple worker nodes 122 of an orchestrated container cluster. In an example, a worker node hosts one or multiple instances of a particular microservice of the application, and each instance may be provided by a corresponding container pod of the worker node. In an example, the pods of a worker node run in a container that is allocated to and started in a virtual machine (VM) 132 of a virtualization resources layer 130 (or “virtualization layer”). In another example, a worker node may correspond to a collection of bare-metal resources of the computer platform 110-1. In addition to the VMs 132, the virtualization resources layer 130 includes a hypervisor 134, which manages the VMs 132 and abstracts physical resources of the computer platform 110 to create virtual resources for the VMs 132. In an example, the hypervisor 134 is a type one hypervisor that runs on top of bare metal resources of the computer platform 110-1. In another example, the hypervisor 134 is a type two hypervisor that runs on top of a host operating system 145 of the computer platform 110-1.

The computer platform 110-1 includes an infrastructure resources layer 140 (or “infrastructure layer”). The infrastructure resources layer 140 includes hardware resources 141, which correspond to the actual, or physical, resources of the computer platform 110-1. In examples, the hardware resources 141 include CPU cores, GPU cores, memory devices, network resources (e.g., network interface controllers) and storage resources (e.g., one or multiple solid state drives (SSDs)). The infrastructure resources layer 140 further includes a host operating system 145. Examples of operating systems include any or some combination of the following: a LINUX operating system, a MICROSOFT WINDOWS operating system, a MAC operating system, a FREEBSD operating system, and so forth.

The physical resources of the infrastructure resources layer 140 are abstracted by the hypervisor 134 to provide virtual resources 143 for the VMs 132. The virtual resources 143 includes virtual GPU cores 142, virtual CPU cores 144, virtual storage resources 148, virtual network resources 147, virtual network overlays, virtual local area networks (VLANs), storage logical unit numbers (LUNs), as well as other virtual abstractions of underlying physical resources. The hypervisor 134 further abstracts the host operating system 145 to provide guest operating systems for the VMs 132.

In accordance with example implementations, the collector agents 150 are distributed among the layers 120, 130 and 140 of the computer platform 110-1. The collector agents 150 provide, to the operations management agent 184, data that represents interlayer dependencies among the components of the layers 120, 130 and 140. Collectively, the collector agents 150 for all of the computer platforms 110 of the distributed system 113 provide data that represents interlayer dependencies for the application's service stack.

In examples, the collector agents 150 are located in worker nodes (e.g., kubelets), VM guest operating systems and the operating system 145. In an example, the collector agents 150 periodically send messages reporting interlayer dependency data to the operations management agent 184. In another example, the interlayer dependency data reporting is event-driven, and a given collector agent 150 sends a message to the operations management agent 184 when an interlayer dependency data associated with the collector agent 150 changes.

Among other features of the computer network 100, the IT operations management platform 181 includes one or multiple processing nodes 190. In an example, a processing node 190 may be a computer platform, such as a server (e.g., an enclosure-based server, a rack-based server or a tower server) or other hardware processor-based electronic device. The processing node 190 includes one or multiple hardware processors 192 and a memory 194. In an example, a hardware processor 192 includes one or multiple CPU cores and/or one or multiple GPU cores. In another example, a hardware processor 192 includes one or multiple semiconductor CPU packages (or “sockets”).

The memory 194, as well as the other memories that are described herein, is a transitory storage media that corresponds to semiconductor storage devices, memristor-based storage devices, magnetic storage devices, phase change memory devices, a combination of devices of one or more of these storage technologies, and so forth. The memory 194 may correspond to both volatile memory devices and non-volatile memory devices.

In an example, one or multiple hardware processors 192 on one or multiple processing nodes 190 execute machine-readable instructions, such as machine-readable instructions 196 that are stored in the memory 194, for purposes of providing one or multiple software components of the IT operations management platform 181, such as the operations management agent 184. In accordance with further implementations, a hardware processor 192 may is a hardware circuit that does not execute machine-readable instructions. In examples, the hardware circuit may be an application specific integrated circuit (ASIC), field programmable gate array (FPGA), programmable logic device, a programmable logic device (PLD), or other hardware dedicated to providing one or multiple functions for the IT operations management platform 181.

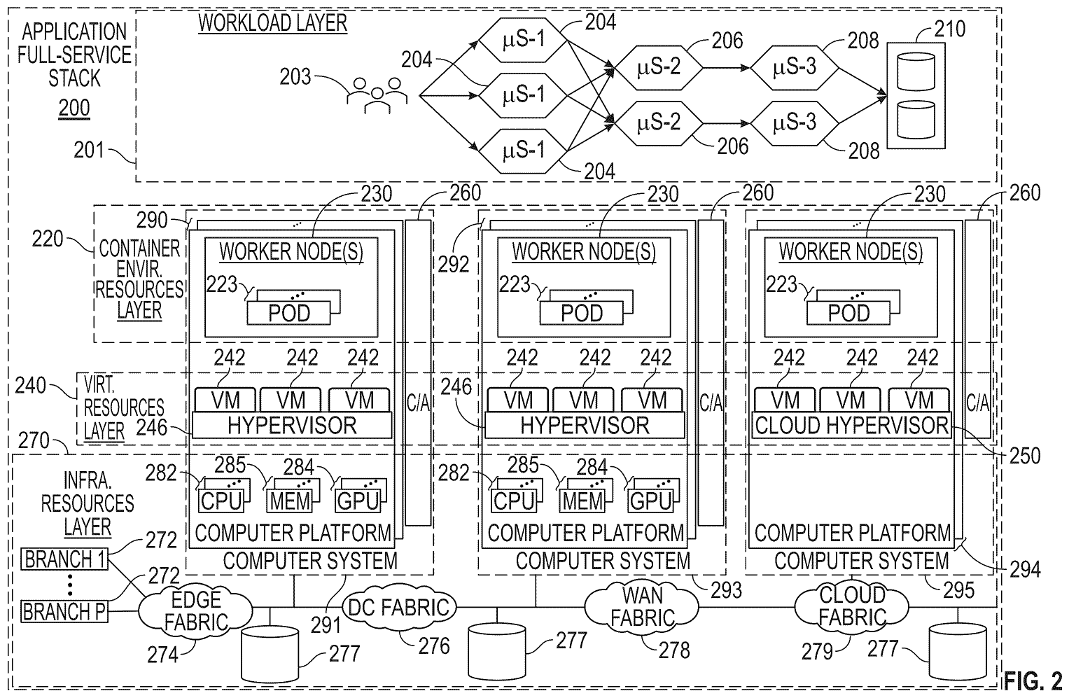

FIG. 2 depicts a full-service stack 200 of a microservice-based application, in accordance with example implementations. The microservices of the application are deployed across multiple computer systems 291, 293 and 295 of a distributed system. In an example, the computer systems 291, 293 and 295 correspond to an edge computing system (e.g., a private cloud), a private cloud and a public cloud, respectively. The computer systems 291, 293 and 295 include respective collections of computer platforms 290 (for the computer system 291), 292 (for the computer system 293) and 294 (for the computer system 295). In examples, the computer platforms 290, 292 and 294 are servers (e.g., enclosure-based servers, rack-based servers, tower servers, or a combination of the foregoing). The computer platforms of a particular computer system 291, 293 or 295 may be located at one or multiple geographical locations. Moreover, the computer platforms of a particular computer system 291, 293 or 295 may be located in one or multiple datacenters.

As depicted in FIG. 2, the computer system 291 may be connected by edge network fabric 274 to local branches 272 (P local branches 272 being depicted in FIG. 2), such as LAN branches. In examples, a local branch may provide network connectivity for edge devices. In examples, edge devices may include Internet of Things (IoTs) devices, client devices (e.g., tablets, desktop computers, laptop computer, tablet computers and smartphones), edge computing systems and edge storage systems. In an example, the computer system 291 corresponds to one or multiple datacenters, and the computer platforms of the datacenter(s) are interconnected by datacenter network fabric 276. In an example, the computer system 293 corresponds to one or multiple datacenters, and the computer platforms of the datacenter(s) are interconnected by the datacenter network fabric 276. Depending on the particular implementation, the datacenter network fabric 276 may include WAN network fabric to connect datacenters that are located at different geographical locations. WAN network fabric 278 in combination with cloud network fabric 280 connects the computer systems 291 and 293 to the computer system 295. In an example, the computer system 295 includes shared resources that are associated with a public cloud service provider. These resources are connected to cloud network fabric 279. The datacenter network fabric 276, the WAN network fabric 278 and the cloud network fabric 279 connect the computer systems 291, 293 and 295 to storage systems 277. In examples, the storage systems 277 may be LAN storage systems and/or storage area network (SAN) storage systems.

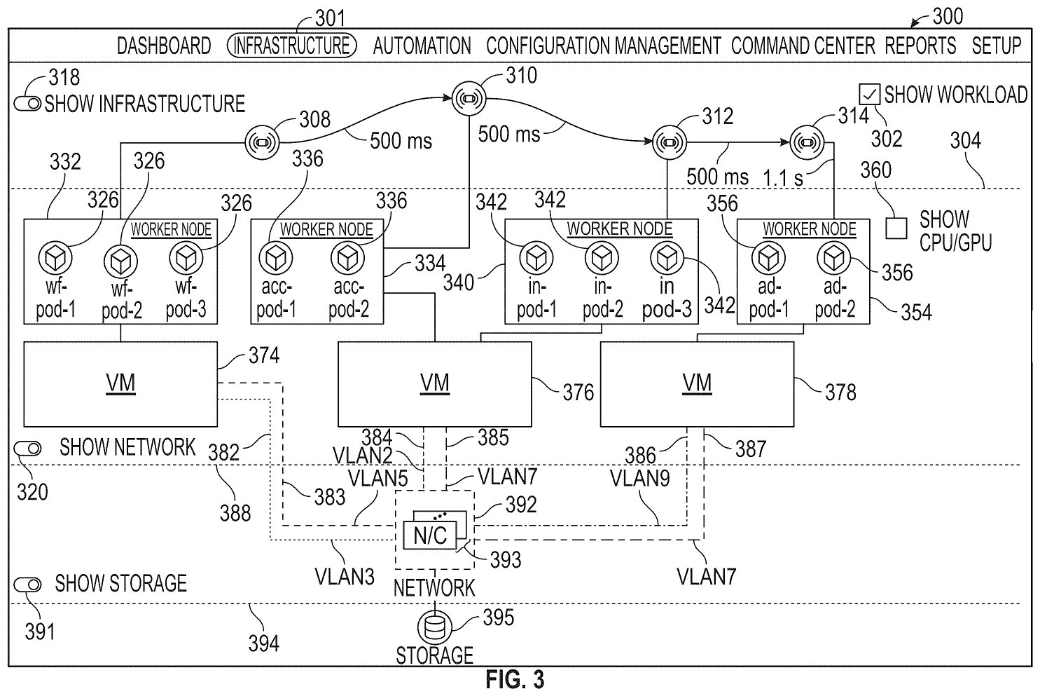

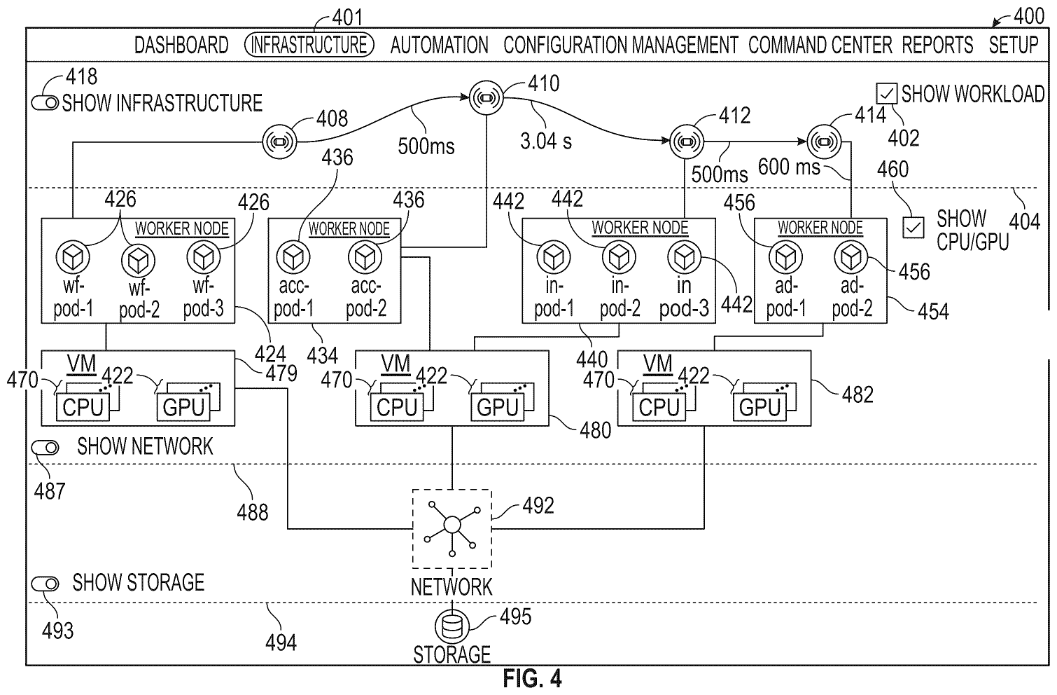

FIG. 2 does not depict the interlayer dependencies of the full-service stack 200. In the context that is used herein, an “interlayer dependency” (or “dependency”) refers to a relationship, or association, between one or multiple components of one layer of an application's service stack and one or multiple components of another layer of the service stack. Graphically-displayed service stack maps that are described herein and in particular, in examples that are depicted in FIGS. 3 and 4, show such interlayer dependencies.

Still referring to FIG. 2, a workload layer 201 (or “application services layer 201”) is the top, or uppermost, layer of the full-service stack 200. The workload layer 201 corresponds to a workflow of workloads of the application. As such, the workload layer 201 corresponds to application services of the full-service stack 200. More specifically, the workloads correspond to respective microservice instances 204, 206 and 208 that are arranged in a particular workflow, or processing sequence. Microservices instances 204, in an example, correspond to multiple instances of a microservice that provides a user interface, as depicted at 203. In an example, the microservice instances 204 may be associated with providing a virtual assistant or other interface to handle or process input data for the workflow. Microservice instances 206, in an example, are multiple instances of a microservice that provides more computationally-intensive processing, such as machine learning-based model training, tuning machine learning-models, training inferences models, or other tasks. Microservice instances 208, in an example, are multiple instances of a microservice that interface with a database 210, such as a microservice that provides coding of SQL requests for the database 210. In other examples, the workload layer 201 may be associated with instances of other microservices, such as microservices that correspond to embedding models, microservices that perform data inference, as well as other artificial intelligence-related microservices as well as microservices that do not provide artificial intelligence-related functions.

The microservice instances 204, 206 and 208 of the workload layer 201 correspond to worker nodes 230 of a container environment resources layer 220 (or “container environment layer 220”) of the full-service stack 200. As depicted in FIG. 2, the worker nodes 230 are hosted on, and distributed across, the computer systems 291, 293 and 295. Each worker node 230 includes one or multiple container pods 223. In an example, a container pod 223 corresponds to a microservice instance. In an example, a worker node 230 contains container pods 223 that correspond to multiple instances of the same microservice.

The worker nodes 230 are hosted on VMs 242 of a virtualization resources layer 240 (or “virtualized infrastructure layer 240”) of the full-service stack 200. As depicted in FIG. 2, the VMs 242 are hosted on, and distributed across, the computer systems 291, 293 and 295. The virtualization resources layer 240 further includes a hypervisor 246 for each computer platform 290 and 292 of the computer systems 291 and 293. The computer platform 294 of the computer system 295, for the example implementation of FIG. 2, correspond to a public cloud and contain public cloud hypervisors 250.

The full-service application service stack 200 further includes an infrastructure resources layer 270 (or “physical infrastructure layer 270”), which is a layer of the stack 200 below the virtualization resources layer 240. The infrastructure resources layer 270 includes the actual, or physical, resources of and associated with the computer systems 291, 293 and 295. As depicted in FIG. 2, for each of the computer systems 291 and 293, the physical resources include physical compute resources, such as physical CPU cores 282 and physical GPU cores 284. The compute resources 280 also includes host operating systems and physical memories 285.

The computer system 295 also has an infrastructure resources layer. However, due to the computer system 295 being associated with a public cloud, there is limited to no visibility of the physical resources of the computer system 295, and these physical resources are not depicted in FIG. 2.

The infrastructure resources layer 270 may further include local network devices (e.g., network interface controllers (NICs)) and local storage devices (e.g., solid state disks (SSDs)). Moreover, the infrastructure resources layer 270 may further include physical resources that are connected to the computer systems 291, 293 and 295, such as the physical storage components (e.g., specific drives) of the storage systems 277 and network devices (e.g., switches, routers, gateway and bridges) of the edge network fabric 274, the datacenter network fabric 276, the WAN network fabric 278 and the cloud network fabric 279.

The physical resources of the infrastructure resources layer 270 are abstracted by the hypervisors to provide virtual resources, and as such, the infrastructure resources layer 270 is also associated with virtual resources, which are consumed by the VMs. These virtual resources include, as examples, virtual memory allocations (abstracted from the physical memories 285), virtual GPU cores (abstracted from the physical GPU cores 284), virtual CPU cores (abstracted from the physical CPU cores 282), virtual storage devices, virtual network devices, virtual network overlays, VLANS, LUNs, as well as other virtual abstractions of underlying physical resources. Moreover, the virtual resources associated with the infrastructure resources layer 270 further include guest operating systems for the VMs.

The computer systems 291, 293 and 295 include collector agents 260 that gather data representing layer interdependencies of the full-service stack 200. For a computer system that has full visibility of the infrastructure resources layer 270, such as the computer system 291 or the computer system 293, the collector agents 260 extend across the container environment resources layer 220, the virtualization resources layer 240 and the infrastructure resources layer 270. For a computer system for which there is no or limited visibility of its infrastructure resources layer 270, such as the computer system 295, the collector agents 260 extend across the container environment resources layer 220 and the virtualization resources layer 240.

The collector agents 260 may take on any of a number of different forms, depending on the particular implementation. In an example, for the container environment resources layer 220, each worker node 230 may include a collector agent 260. In an example, for a KUBERNETES container cluster, a collector agent 260 may be part of a kubelet. A collector agent 260 of the container environment resources layer 220 gathers information about the interlayer dependencies between the container environment resources layer 220 and the virtualization resources layer 240. In an example, a collector agent 260 for a worker node 230 determines a VM ID for the VM 242 upon which the worker node 230 is deployed. In an example, a collector agent 260 of the container environment resources layer 220 periodically sends, to a service stack mapping service (e.g., the mapping service 182 of FIG. 1), messages containing data representing the interlayer dependencies. In another example, the sending of the messages is event-based. In an example, a collector agent 260 of the container environment resources layer 220 sends, to a service stack mapping service, a message containing data representing any change, addition to, or deletion of, an interlayer dependency for which the collector agent 260 is responsible.

In another example of a collector agent 260, the collector agent 260 may be part of a guest operating system kernel of a VM 242. In an example, the collector agent 260 is a kernel module of the guest operating system. In an example, for a LINUX guest operating system, the collector agent 260 is a kernel driver. In another example, for a LINUX guest operating system, the collector agent 260 is an eBPF module. An eBPF module is a program that is outside of the compiled LINUX core and runs in a sandbox in a privileged context inside the LINUX kernel. Although initially, the acronym “eBPF” referred to an “extended Berkeley Packet Filter,” the term “eBPF” is a standalone term that encompasses privileged context and sandboxed programs other than programs that perform packet filtering. In another example, a collector agent 260 is part of, and therefore integrated into, the guest operating system kernel. In an example, a collector agent 260 of a guest operating system determines virtual resource associations (e.g., VLAN IDs, LUN IDs, network overlay associations, as well as other virtual resource associations) for the corresponding VM 242. In an example, the collector agent 260 of the virtualization resources layer 240 sends, to a service stack mapping service, messages containing data representing the interlayer dependencies. In examples, the sending of the messages is event-based or periodic.

In another example, a collector agent 260 for the infrastructure resources layer 270, is part of a host operating system kernel. In an example, the collector agent 260 is a kernel module of the host operating system, such as an eBPF module or a kernel driver. In another example, a collector agent 260 is part of, and therefore integrated into, the host operating system kernel. In an example, a collector agent 260 of a host operating system determines IDs and characteristics (e.g., sizes) of physical resources (e.g., CPU cores 282, GPU cores 284, memories 285, NICs, SSDs, network devices, storage devices and storage systems) of the corresponding computer system and sends, to a mapping service, messages containing this information. This interlayer dependency information, in turn, ties the resources of the virtualization resources layer 240, such as the VMs 242 that are hosted by the computer system, to physical hardware resources from which virtual resources for the virtualization resources layer 240 are allocated. In an example, the collector agent 260 of the infrastructure resources layer 270 sends, to a service stack mapping service, messages containing data representing the interlayer dependencies. In examples, the sending of the messages is event-based or periodic.

FIG. 3 depicts a full-service stack map 300 for a microservice-based application, in accordance with example implementations. In an example, the microservices of the application are distributed across multiple computer systems of a distributed system. Moreover, the computer systems may be associated with a mixture of one or multiple public clouds, one or multiple private clouds and possibly non-cloud systems. In an example, the service stack map 300 may be provided by a GUI, such as, for example, the GUI 168 of FIG. 1. Moreover, the GUI generates the service stack map 300 based on data that is generated and provided by a service stack mapping service, such as the mapping service 182 of FIG. 1 responsive to interlayer dependency data that is acquired by the service 182 from collector agents, such as the collector agents 150 (FIG. 1) or collector agents 260 (FIG. 2).

Referring to FIG. 3, the service stack map 300 may be selected as an infrastructure option 301 of the GUI. As depicted in FIG. 3, the GUI may present several viewing configuration options, such as an option 318 (e.g., selectable via a slidable button) to show the physical and virtual infrastructure, an option 302 (e.g. selectable by checking a box) to show the workload layer, an option 320 (e.g., selectable via a slidable button 320) to display network details in an infrastructure resources layer and an option 391 (e.g., selectable via a slidable button) to show storage components of the infrastructure resources layer. Moreover, as depicted at 360, the GUI may further provide an option 360 (selectable by checking a box) to show specific infrastructure components, such as displaying or not displaying virtual CPU allocations and/or virtual GPU allocations. As also depicted in FIG. 3, in accordance with some implementations, the service stack map 300 may include horizontal dividers 304, 388 and 394, such as horizontal lines, which demarcate layers of the service stack map 300.

For the example implementation that is depicted in FIG. 3, a workload layer (or “application services layer”), which is above the layer demarcation line 304, depicts services of the application, such as microservices 308, 310, 312 and 314. For this example, the microservices 308, 310, 312 and 314 are sequentially arranged. However, in accordance with further implementations, one or multiple microservices of an application may perform their respective processes in parallel.

In an example, the microservice 308 performs one or multiple user interface-related functions. In an example, the microservice 308 may provide a virtual assistant for the application. In another example, the microservice 308 performs machine learning model-based inference. The microservice 308 is associated with a worker node 332. The worker node 332 is part of the container environment resources layer. The worker node 332 includes container pods 326 that, in accordance with example implementations, correspond to respective instances of the microservice 308.

The microservice 308 provides an output to another microservice 310 of the application. In an example, the microservice 310 performs computationally-intensive processing for the application. In an example, the microservice 310 applies embedding models to real world data. In another example, the microservice 310 performs machine learning model-based inference. Regardless of its particular function, the microservice 310 corresponds to a worker node 334. In an example, the worker node 334 includes container pods 336 that correspond to respective instances of the microservice 310.

As further depicted by the service stack map 300, the microservice 310 provides an output to another microservice 312 of the application. In examples, the microservice 312 may perform computationally-intensive operations. In examples, the microservice 312 performs machine learning-based model training. In another example, the microservice 312 tunes parameters of machine learning models. As depicted by the service stack map 300, the microservice 312 corresponds to a worker node 340 that has associated container pods 342. In an example, the container pods 342 correspond to respective instances of the microservice 312.

The service stack map 300 further depicts the microservice 312 providing input to a microservice 314 of the application. In an example, the microservice 314 may provide an output-related function for the application. In an example, the microservice 314 is a SQL coder. As depicted by the service stack map 300, the microservice 314 corresponds to a worker node 354. Container pods 356 of the worker node 354 correspond to, in an example, instances of the microservice 314.

The service stack map 300 may also display one or multiple performance characteristics associated with the microservices of an application. As depicted in the example of FIG. 3, the service stack map 300 depicts latencies of 500 milliseconds (ms) associated with the microservices 308, 310 and 312; and the service stack map 300 further depicts a processing latency of 1.1 s for the microservice 314. For this example, the 1.1 s processing latency of the microservice 314 may be unacceptable (e.g., may not correspond to a service layer agreement (SLA) requirement or may be unacceptable for another reason).

The service stack map 300, in accordance with example implementations, represents a dependency topology, which allows an issue that is associated with applications services, the virtualized infrastructure or the physical infrastructure to be traced, via the service stack map 300, to identify the most likely, or probable, cause of the issue. For the example that is depicted in FIG. 3, the service stack map 300 serves as a tool to find the underlying root cause of the relatively slow processing latency of the microservice 314. More specifically, the service stack map 300 depicts three VMs 374, 376 and 378. The service stack map 300 associates the worker node 332 with the VM 374. Moreover, the service stack map 300 associates the worker nodes 334 and 340 with the same VM 376, and the service stack map 300 further associates the worker node 354 with the VM 378. As further depicted in FIG. 3, the service stack map 300 associates the VMs 374, 376 and 378 with different VLAN IDs. In particular, as depicted at 382 and 383 of the service stack map 300, the VM 374 is associated with VLAN5 and VLAN3 IDs. As depicted at 384 and 385, the service stack map 300 associates the VM 376 with VLAN2 and VLAN7 IDs. Moreover, as depicted at 386 and 387, the service stack map 300 associates the VM 378 with VLAN7 and VLAN9 IDs. In an example, the GUI may display the VLAN associations responsive to a user selecting (e.g., selecting via mouse clicks) connections between a VM and a network 392 of the service stack map 300, and the GUI may display network components 393 of the network 392.

For this example, the issue with the relatively slow processing latency of the microservice 314 is a network-affiliated problem. In an example, the root cause may be that the VM 378 (which hosts instances 356 of the microservice 314) uses a VLAN7 ID that is the same VLAN7 ID assigned to the VM 376 (which hosts instances 342 of microservice 312) that generates a high volume of network traffic. As such, in an example, there may be a virtual resource contention problem due to traffic congestion in a particular broadcast domain. In another example, there may be a physical network allocation problem due to the VLAN7 virtual network not being assigned to a sufficient number of physical ports. In another example, the VM 378 associated with the microservice 314 may be assigned to a VLAN virtual network that has a configuration problem, a physical disconnection, or other problem.

In other examples of potential resource contention problems, microservices that share the same virtual or physical networking resources may have network contention problems due to the microservices having operations that coincide and compete for network resources. Problems with a particular microservice may, in other examples, not be related to network problems. In an example, virtual or physical storage contention may cause microservice performance problems. In another example, VMs may have inadequate resource allocations, as described further below in connection with FIG. 4.

FIG. 4 depicts an example service stack map 400 for a microservice-based application, in accordance with example implementations. Similar to the service stack map 300 of FIG. 3, the service stack map 400 includes various graphical controls to allow the user to configure the specific content that is displayed on the service stack map 400.

The GUI may contain various graphical user controls related to displaying the service stack map 400 and its content. In this manner, as depicted in FIG. 4, the GUI 400 may include an option 401 to display the service stack map 400, an option 418 to an infrastructure of the distributed system, an option 402 to show the workload layer, an option 487 to show network components, an option 493 to show storage components and an option 460 to show virtual CPU core and GPU core resources of the infrastructure resources layer. Moreover, the GUI may present various demarcations for the layers of the service stack map 400, such as the demarcations represented by horizontal lines 404, 484 and 494.

For this example, the service stack map 400 depicts microservices 408, 410, 412 and 414, which correspond to the microservices 308, 310, 312 and 314, respectively, of FIG. 3. Moreover, the microservices 408, 410, 412 and 414 correspond to worker nodes 424, 434, 440 and 454 that correspond to the worker nodes 332, 334, 340 and 354, respectively, of FIG. 3. The worker node 424 includes container pods 426 that correspond to the microservice 408, the worker node 434 container pods 436 that correspond to the microservice 410, the worker node 440 contains container pods 442 that corresponds to the microservice 412 and the worker node 454 contains container pods 456 that correspond to the microservice 414. Moreover, the worker node 424 is deployed to a VM 479, and the worker node 454 is deployed to the VM 482. The worker nodes 434 and 440 are deployed to the same VM 480.

For this example, the microservices 410 and 412 each has a processing latency of 500 ms, and the microservice 414 has a processing latency of 600 ms. As depicted in FIG. 4, the service stack map 400 depicts the microservice 410 having a processing latency of 3.04 s, which, for this example, is unacceptably large. As depicted in FIG. 3, the service stack map 400 associates two microservices 410 and 412 with the same VM 480. A user may determine, based on the service stack map 400, that there is a GPU core contention problem with the microservices 410 and 412.

FIG. 4 depicts, for each VM 479, 480 and 482, a collection of allocated virtual CPU cores 470 and virtual CPU cores 422. In an example, it may be determined that due to the relatively large virtual GPU core allocation for the microservices 410 and 412, the corresponding host does not have an adequate number of GPU cores to accommodate the virtual GPU core allocation. Consequentially, a potential resolution may be assigning the microservices 410 and 412 to VMs on different hosts. In another example, a user may determine, from the service stack map 400, that the VM does not have a sufficiently high GPU resource allocation and the resolution may be to increase the virtual GPU core allocation for the VM 480. In another example, a user may determine from the service stack map 400 that the virtual CPU allocation for the VM 480 is insufficient, and a resolution may be to increase the virtual CPU core allocation. In another example, a user may determine, from the service stack map 400, that the number of physical CPU cores of the host are not adequate for the VM 480, and a resolution may be to assign the microservices 410 and 412 to VMs of different host computer platforms. In another example, a user may determine, from the service stack map 400, that the VM 480 does not have an adequate virtual memory allocation, and a solution may be to assign more virtual memory to the VM 480. In another example, it may be determined that the underlying physical memory of the host computer platform is not adequate, and a resolution may be to assign the microservices 410 and 412 to VMs on different host computer platforms.

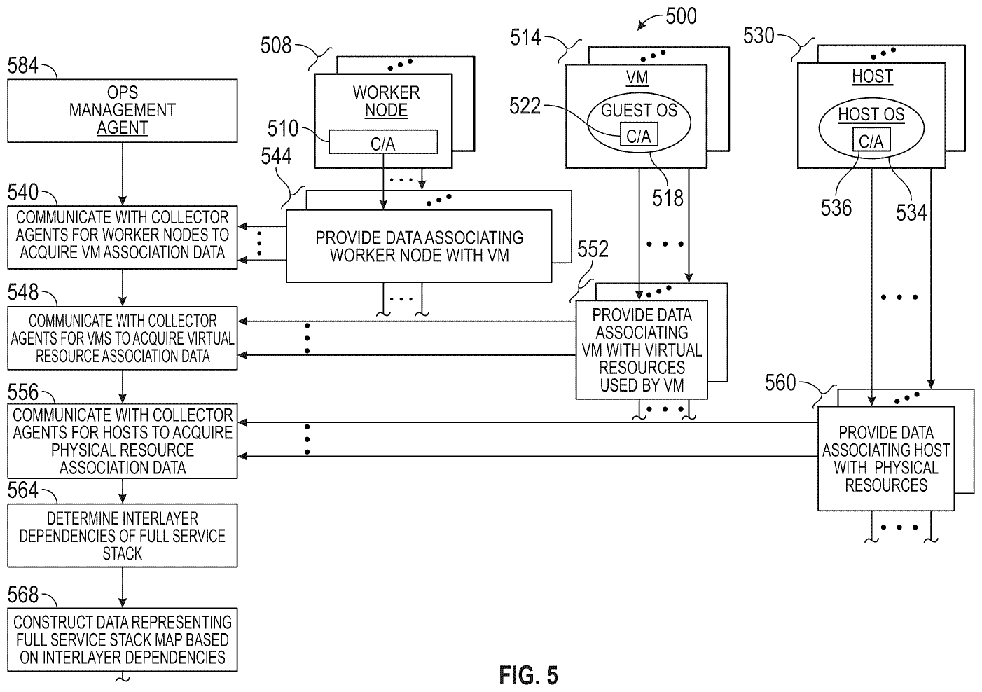

FIG. 5 depicts a sequence flow diagram 500 illustrating operations performed by components associated with a mapping service, such as the mapping service 182 of FIG. 1, for purposes of deriving a service stack map for an application. The application has microservices that are deployed on a distributed system. More specifically, the components associated with the mapping service includes an operations management agent 584, worker nodes 508, VMs 514 and hosts 530. The worker nodes 508 may include respective collector agents 510. In an example, the collector agents 510 may be kubelets. The VMs 514 also include respective collector agents 522. In an example, a collector agent 522 may be part of a guest operating system 518 of the VM 514. In examples, the collector agent 522 may be a kernel driver or eBPF module. The hosts 530 includes respective collector agents 536. In an example, the collector agent 536 may be part of a host operating system 534. In examples, the collector agent 536 may be a kernel driver or an eBPF module of the host operating system 534.

The collector agents 510, 522 and 536 gather data that represents interlayer dependencies of the distributed system. As depicted in FIG. 5, the operations management agent 584 communicates (block 540) with the collector agents 510 of the VMs 508. The VMs 508 provide data associating the worker nodes with respective VMs. Pursuant to block 548, the operations management agent 584 communicates with collector agents 522 of the VMs 514 for purposes of collecting virtual resource association data. The collector agents 522 provide data associating the VMs with virtual resources used by the VMs.

Pursuant to block 556, the operations management agent 584 communicates with collector agents 536 of the host 530 for purposes of acquiring infrastructure resource association data. The collector agents 536 provide data associating the host with resources of the host and which are used by the host. Pursuant to block 564, the operations management agent 584 determines interlayer dependencies of layers of the full-service stack of the application. The operations management agent 584 then constructs (block 568) data representing the full-service stack map based on the interlayer dependencies.

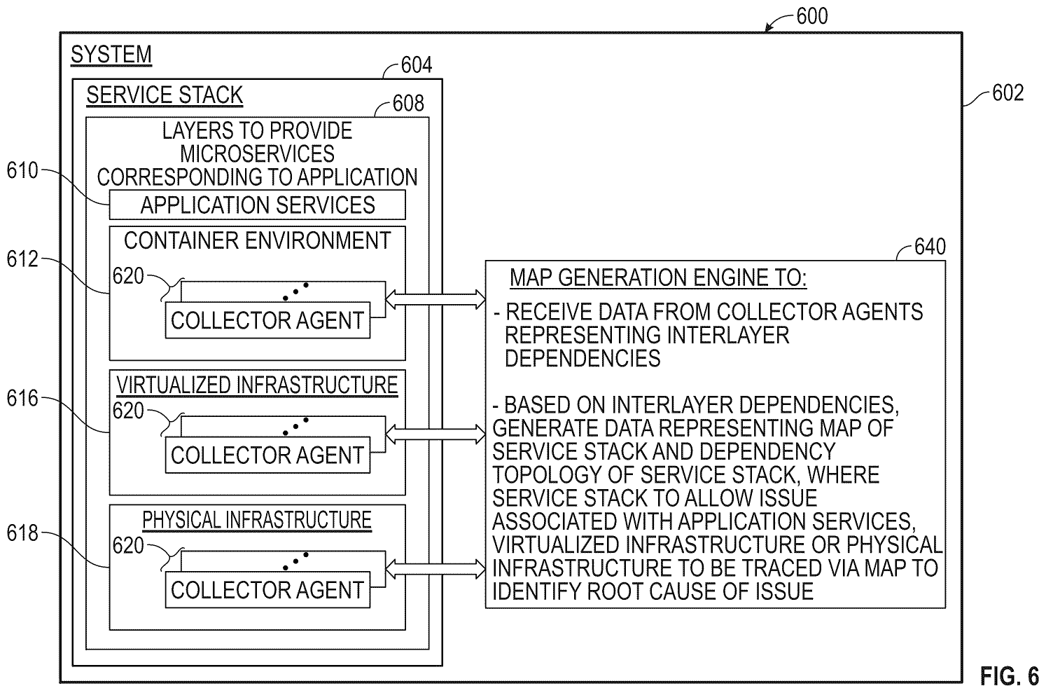

Referring to FIG. 6, in accordance with example implementations, a system 600 includes a service stack 604 and a map generation engine 640. The service stack 604 includes layers 608 to provide microservices that correspond to an application. In an example, the microservices are deployed on a distributed system, and the layers 608 extend across the distributed system. In an example, the distributed system includes computer systems that are disposed at different geographical locations or sites. In an example, the computer systems are associated with private and public clouds. In an example, the computer systems include a system deployed at the network edge.

In an example, the microservices are associated with container pod instances that perform computationally-intensive processing, such as processing related to machine learning-based model generation and parameter tuning. In an example, the microservices are associated with container pod instances that perform machine learning model-based processing and are located in a public cloud. In an example, container pod instances that perform machine learning-based processing receive input from other container pod instances that are deployed in a private cloud.

The layers 608 of the service stack 604 include application services 610 and a container environment 612. In an example, the container environment 612 includes worker nodes, and each worker node has container pod instances that are associated with a particular microservice. In an example, the container environment 612 may be associated with one or multiple orchestrated container clusters, such as KUBERNETES clusters or DOCKER SWARM clusters.

The layers 608 of the service stack 604 further include a virtualized infrastructure 616. In an example, the virtualized infrastructure 616 includes VMs. In an example, the VMs may be managed by hypervisors of the virtualized infrastructure 616. In an example, the hypervisors are type one hypervisors. In other examples, the hypervisors are type two hypervisors. In an example, the VMs host worker nodes. In an example, the VMs are hosted on computer platforms. In an example, a VM is allocated virtual resources, such as virtual GPU cores and/or virtual CPU cores. In an example, a VM is assigned to one or multiple VLANs. In an example, a VM is assigned one or multiple LUNs. In an example, a VM is assigned a virtual memory allocation. In an example, a VM is assigned to a network overlay layer.

The layers 608 of the service stack 604 further include a physical infrastructure 618. In an example, the physical infrastructure 618 corresponds to actual, or physical, resources that are either located on computer platforms or used by the computer platforms. In an example, the physical infrastructure 618 includes physical CPU cores. In another example, the physical infrastructure 618 includes physical GPU cores. The physical infrastructure 618, in another example, includes physical memory. In another examples, the physical infrastructure layer 618 includes storage components. In another examples, the physical infrastructure layer 618 includes networking components. In an example, the physical infrastructure layer 618 includes network-accessible storage systems. In an example, the physical infrastructure 618 includes network devices of network interconnection fabric, such as network fabric that interconnects datacenter and edges, and network fabric that provides public cloud and WAN connectivity.

In an example, the physical resources of the physical infrastructure 618 are abstracted by hypervisors to provide the virtual resources for the VMs, and as such, the physical infrastructure 618 is also associated with virtual resources for the VMs. These virtual resources include virtual GPU cores, virtual CPU cores, virtual storage devices, virtual network devices, virtual network overlays, VLANs, LUNs.

The service stack 604 includes collector agents 620, located in the container environment 612, the virtualized infrastructure 616 and the physical infrastructure 618 to collect data representing interlayer dependencies. In an example, the collector agents 620 include worker node-based agents (e.g., kubelets) in the container environment layer 612. In another example, in the virtualization layer 616, the collector agents 620 are part of VM guest operating system kernels. In an example, a collector agent 620 of the virtualization layer 616 is a VM guest operating system kernel driver. In another example, a collector agent 620 of the virtualized infrastructure 616 is a VM guest operating system eBPF module. In an example, in the physical infrastructure 618, the collector agents 620 are part of host operating system kernels. In examples, in the physical infrastructure 618, the collector agents 620 may be kernel drivers or eBPF modules of respective host operating system kernels.

The map generation engine 640, in an example, is associated with an IT operations management platform. In an example, the IT operations management platform is a public cloud-based platform that provides a suite of services, including a service to generate service stack maps. The map generation engine 640 receives data from the collector agents 620 based on the interlayer dependencies, generate data representing a map of the service stack (e.g., a map of the full-service stack) and dependency topology of the service stack. The service stack allows an issue associated with the application services 610, the virtualized infrastructure 616 or the physical infrastructure 618 to be traced via the map to identify a root cause (e.g., the most likely root cause) of the issue.

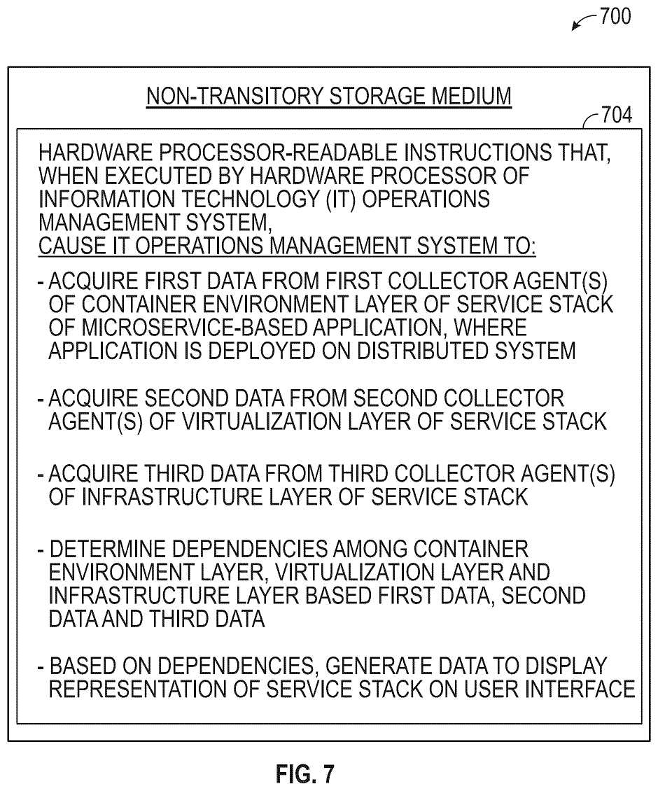

Referring to FIG. 7, in accordance with example implementations, a non-transitory storage medium stores hardware processor-readable instructions 704. The instructions 704, when executed by a hardware processor of an IT operations management system, cause the IT operations management system to acquire first data from first collector agents of a container environment layer of a service stack of a microservice-based application. The application is deployed on a distributed system. In an example, the distributed system includes computer systems that are disposed at different geographical locations or sites. In an example, the computer systems are associated with private and public clouds. In an example, the computer systems include a system deployed at the network edge. In an example, the microservices are associated with container pod instances that perform computationally-intensive processing, such as processing related to machine learning-based model generation and parameter tuning. In an example, the microservices are associated with container pod instances that perform machine learning model-based processing and are located in a public cloud. In an example, container pod instances that perform machine learning-based processing receive input from other container pod instances that are deployed in a private cloud.

In an example, the container environment layer includes worker nodes, and each worker node has container pod instances that are associated with a particular microservice. In an example, the container environment layer may be associated with one or multiple orchestrated container clusters. In an example, the first collector agents are worker node-based agents.

The instructions 704, when executed by the hardware processor, further cause the IT operations management system to acquire second data from second collector agents of a virtualization layer of the distributed system. In an example, the virtualization layer includes VMs. In an example, a VM is allocated virtual resources, such as virtual GPU cores and/or virtual CPU cores. In an example, a VM is assigned to one or multiple VLANs. In an example, a VM is assigned one or multiple LUNs. In an example, a VM is assigned a virtual memory allocation. In an example, a VM is assigned to a network overlay layer. In an example, the second collector agents correspond to VM guest operating system kernels. In an example, a second collector agent is a VM guest operating system kernel driver. In another example, a second collector agent is a VM guest operating system eBPF module.

The instructions 704, when executed by the hardware processor, further cause the IT operations management system to acquire third data from third collector agents of an infrastructure layer of the distributed system. In an example, the infrastructure layer includes actual, or physical, resources that are either located on computer platforms or used by the computer platforms. In an example, the infrastructure layer includes physical CPU cores. In another example, the infrastructure layer includes physical GPU cores. The infrastructure layer, in another example, includes physical memory. In another examples, the infrastructure layer includes storage components. In another examples, the infrastructure layer includes networking components. In an example, the infrastructure layer includes network-accessible storage systems. In an example, the infrastructure layer includes network devices of network interconnection fabric, such as network fabric that interconnects datacenter and edges, and network fabric that provides public cloud and WAN connectivity. In examples, the third collectors may be eBPF modules or kernel drivers of host operating system kernels. In an example, the physical resources of the infrastructure layer are abstracted by hypervisors to provide the virtual resources for the VMs, and as such, the infrastructure layer is also associated with virtual resources for the VMs. These virtual resources include virtual GPU cores, virtual CPU cores, virtual storage devices, virtual network devices, virtual network overlays, VLANs, LUNs.

The instructions 704, when executed by the hardware processor, further cause the IT operations management system to determine dependencies among the container environment layer, the virtualization layer and the infrastructure layer based on the first data, the second data and the third data. In an example, a dependency associates a worker node of the container environment layer with a VM of the virtualization layer. In another example, a dependency associates a VM the container environment layer with virtual resources. In another example, a dependency associates a VM the container environment layer with physical resources.

The instructions 704, when executed by the hardware processor, further cause the IT operations management system to, based on the dependencies, generate data to display a representation of the service stack map on a user interface. In an example, the instructions 704 cause the IT operations management system to display the representation on a user-interactive GUI, which has graphical controls to manipulate how the representation is displayed. In an example, the instructions 704 further cause the IT operations management system to generate data that represents a workload layer associated with the microservices and associates the microservices with container pod instances.

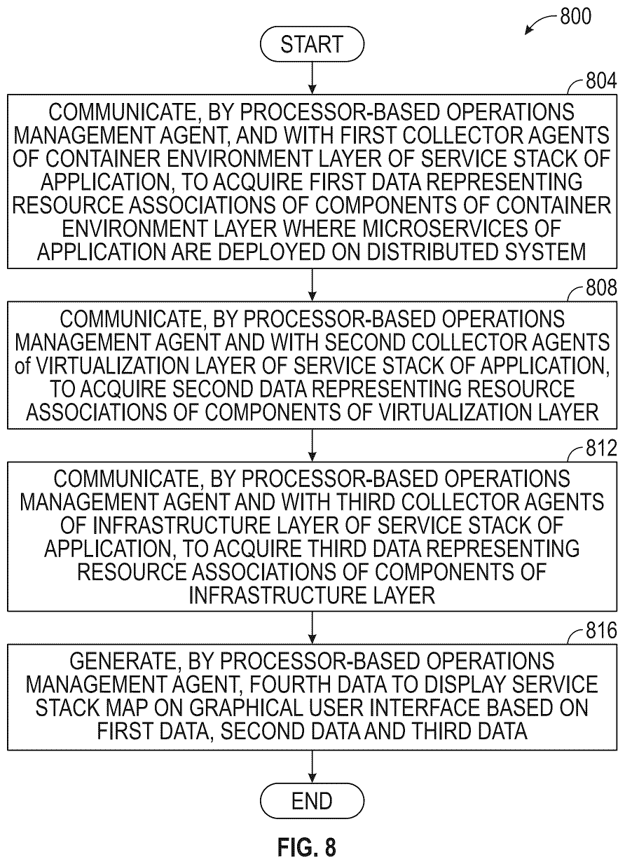

Referring to FIG. 8, in accordance with example implementations, a technique 800 includes communicating (block 804), by a processor-based operations management agent and with first collector agents of a container environment layer of a service stack of an application, to acquire first data representing resource associations of components of the container environment layer. Microservices of the application are deployed on a distributed system. In an example, the operations management agent provides a mapping service for an IT operations management platform. In an example, the IT mapping service is a cloud service corresponding to an as-a-Service. In an example, the container environment layer includes worker nodes associated with one or multiple orchestrated container clusters. In an example, the container environment layer hosts container pod instances that correspond to microservice instances. In an example, a worker node of the container environment layer includes multiple container pod instances that correspond to multiple instances of the same microservice.

In an example,

In an example, the microservices are associated with container pod instances that perform computationally-intensive processing, such as processing related to machine learning-based model generation and parameter tuning. In an example, the microservices are associated with container pod instances that perform machine learning model-based processing and are located in a public cloud. In an example, container pod instances that perform machine learning-based processing receive input from other container pod instances that are deployed in a private cloud.

In an example, the first collector agents are part of the worker nodes. In an example, the first collector agents are kubelets. In an example, the first collector agents send, to the processor-based operations management agent, messages containing data representing the resource associations. In examples, the first collector agents may send the messages periodically or in response to changes in the resource associations. In examples, the resource associations associate worker nodes with VMs of a virtualization layer.

The technique 800 includes communicating (block 808), by the processor-based operations management agent and with second collector agents of a virtualization layer of the service stack, to acquire second data representing resource associations of a virtualization layer. In an example, the virtualization layer includes VMs that host the worker nodes. In an example, the second collector agents are part of the guest operating system kernels of the VMs. In an example, the second collector agents are eBPF modules of the guest operating system kernels. In another example, the second collector agents are kernel drivers of the guest operating system kernels. In another example, the second collector agents are integrated into the guest operating system kernels. In an example, the second collector agents send, to the processor-based operations management agent, messages containing data representing the second connections. In examples, the second collector agents may send the messages periodically or in response to changes in the second connections. In examples, the resource associations associate VMs with virtual resource allocations, such as allocations of virtual GPU cores and/or allocations of virtual CPU cores. In another example, the resource associations associate VMs with VLAN IDs. In another example, the resource associations associate VMs with LUN IDs. In another example, the resource associations associate VMs with virtual memory allocations. In another example, the resource associations associate VMs with network overlay layers.

The technique 800 includes communicating (block 812), by the processor-based operations management agent, with third collector agents of the service stack to acquire third data representing resource associations of the components of the infrastructure layer. In an example, the infrastructure layer includes physical resources that are either located on computer platforms or used by the computer platforms. In an example, the infrastructure layer includes physical CPU cores. In another example, the infrastructure layer includes physical GPU cores. The infrastructure layer, in another example, includes physical memory. In another example, the infrastructure layer includes storage components. In another example, the infrastructure layer includes networking components. In an example, the infrastructure layer includes network-accessible storage systems. In an example, infrastructure layer includes network devices of network interconnection fabric, such as network fabric that interconnects datacenter and edges, and network fabric that provides public cloud and WAN connectivity. In an example, the physical resources of the infrastructure layer are abstracted by hypervisors to provide the virtual resources for the VMs, and as such, the infrastructure layer is also associated with virtual resources for the VMs. These virtual resources include virtual GPU cores, virtual CPU cores, virtual storage devices, virtual network devices, virtual network overlays, VLANs, LUNs.

In examples, the third collectors may be eBPF modules or kernel drivers of host operating system kernels. In an example, the third collector agents send, to the processor-based operations management agent, messages containing data representing resource associations. In examples, the third collector agents may send the messages periodically or in response to changes in the resource associations.

The technique 800 includes generating (block 816), by the processor-based operations management agent, fourth data to display a service stack map on a graphical user interface based on the first data, the second data and the third data. In an example, the map may be manipulated by graphical user controls to selectively indicate resource associations of layers of the service stack map. In an example, the processor-based operations management agent may further generate data that represents a workload layer, such that the service stack map includes the workload layer. In an example, the workload layer associates the microservices of the application with container pod instances.

In accordance with example implementations, the root cause identified by via the map is the most probable root cause of the issue, and the service stack is a full-service stack. Among the advantages, the service stack map is a tool that allows an issue with a microservice-based application to be traced to its root cause.

In accordance with example implementations, the container environment is associated with an orchestrated container cluster. The virtualization layer includes virtual machine that hosts a worker node of the orchestrated container cluster. The collector agents include a given collector agent to provide data identifying the virtual machine. Among the advantages, the service stack map is a tool that allows an issue with a microservice-based application to be traced to its root cause.

In accordance with example implementations, the container environment includes a worker node. The virtualization layer includes a virtual machine that hosts the worker node. The virtual machine includes a given collector agent to provide data associating virtual resources with the virtual machine. Among the advantages, the service stack map is a tool that allows an issue with a microservice-based application to be traced to its root cause.

In accordance with example implementations, the data associating the virtual resources with the virtual machine includes data representing a virtual local area network (VLAN) identifier. Among the advantages, the service stack map is a tool that allows an issue with a microservice-based application to be traced to its root cause.

In accordance with example implementations, the data associating the virtual resources with the virtual machine includes data representing a logical storage unit (LUN) identifier. Among the advantages, the service stack map is a tool that allows an issue with a microservice-based application to be traced to its root cause.

In accordance with example implementations, the data associating the virtual resources with the virtual machine includes data associating the virtual machine with a network overlay. Among the advantages, the service stack map is a tool that allows an issue with a microservice-based application to be traced to its root cause.

In accordance with example implementations, the virtual machine includes a guest operating system kernel and the given collector agent is part of the operating system kernel. Among the advantages, the service stack map is a tool that allows an issue with a microservice-based application to be traced to its root cause.

In accordance with example implementations, the given collector agent is an eBPF module of the guest operating system kernel. Among the advantages, the service stack map is a tool that allows an issue with a microservice-based application to be traced to its root cause.

In accordance with example implementations, the container environment includes comprises a worker node. The worker node is hosted on a computer platform. The computer platform includes a given collector agent to provide data associating resources with the computer platform. Among the advantages, the service stack map is a tool that allows an issue with a microservice-based application to be traced to its root cause.

In accordance with example implementations, the computer platform includes a host operating system kernel. The host operating system kernel includes the given collector agent. Among the advantages, the service stack map is a tool that allows an issue with a microservice-based application to be traced to its root cause.

In accordance with example implementations, the microservices are distributed across a distributed system of computer systems. Each computer system includes components associated with the plurality of layers. Among the advantages, the service stack map is a tool that allows an issue with a microservice-based application to be traced to its root cause.

In accordance with example implementations, a first computer system of the distributed system is associated with a public cloud, and a second computer system of the distributed system is associated with a private cloud. Among the advantages, the service stack map is a tool that allows an issue with a microservice-based application to be traced to its root cause.

In accordance with example implementations, a first microservice of the microservices is deployed on the first computer system and provides machine learning model-based processing. A second microservice of the microservices is deployed on the second computer system and provides input for the machine learning model-based processing. Among the advantages, the service stack map is a tool that allows an issue with a microservice-based application to be traced to its root cause.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A system comprising:
a service stack comprising a plurality of layers to provide microservices corresponding to an application, wherein the service stack comprises application services, a container environment, a virtualized infrastructure and a physical infrastructure;
a plurality of collector agents located in the container environment, the virtualized infrastructure and the physical infrastructure to collect data representing interlayer dependencies; and
a map generation engine to:
receive the data from the plurality of collector agents; and
based on the interlayer dependencies, generate data representing a map of the service stack and dependency topology of the service stack, wherein the service stack to allow an issue associated with the application services, the virtualized infrastructure or the physical infrastructure to be traced via the map to identify a root cause of the issue.

2. The system of claim 1, wherein the root cause comprises the most probable root cause of the issue, and wherein the service stack comprises a full-service stack.

3. The system of claim 1, wherein:
the container environment is associated with an orchestrated container cluster;
the virtualized infrastructure comprises a virtual machine that hosts a worker node of the orchestrated container cluster; and
the plurality of collector agents comprises a given collector agent to provide data identifying the virtual machine.

4. The system of claim 1, wherein:
the container environment comprises a worker node;
the virtualized infrastructure comprises a virtual machine that hosts the worker node;
the virtual machine comprises a given collector agent of the plurality of collector agents to provide data associating virtual resources with the virtual machine.

5. The system of claim 4, wherein the data associating the virtual resources with the virtual machine comprises data representing a virtual local area network (VLAN) identifier.

6. The system of claim 5, wherein the data associating the virtual resources with the virtual machine comprises data representing a logical storage unit (LUN) identifier.

7. The system of claim 5, wherein the data associating the virtual resources with the virtual machine comprises data associating the virtual machine with a network overlay.

8. The system of claim 4, wherein the virtual machine comprises a guest operating system kernel and the given collector agent is part of the operating system kernel.

9. The system of claim 1, wherein:
the container environment comprises a worker node;
the worker node is hosted on a computer platform; and
the computer platform comprises a given collector agent of the plurality of collector agents to provide data associating resources with the computer platform.

10. The system of claim 9, wherein:
the computer platform comprises a host operating system kernel; and
the host operating system kernel comprises the given collector agent.

11. The system of claim 1, wherein:
the microservices are distributed across a distributed system of computer systems; and
each computer system of the distributed system comprises components associated with the plurality of layers.

12. The system of claim 11, wherein:
a first computer system of the distributed system is associated with a public cloud; and
a second computer system of the distributed system other than the first computer system is associated with a private cloud.

13. The system of claim 12, wherein:
a first microservice of the microservices is deployed on the first computer system and provides machine learning model-based processing; and
a second microservice of the microservices is deployed on the second computer system and provides input for the machine learning model-based processing.

14. A non-transitory storage medium that stores processor-readable instructions that, when executed by a hardware processor of an information technology (IT) operations management platform, cause the IT operations management platform to:
acquire first data from first collector agents of a container environment layer of a service stack of a microservice-based application, wherein the application is deployed on a distributed system;
acquire second data from second collector agents of a virtualization layer of the distributed system;
acquire third data from third collector agents of an infrastructure layer of the distributed system;
determine dependencies among the container environment layer, the virtualization layer and the layer based on the first data, the second data and the third data; and
based on the dependencies, generate data to display a representation of the service stack on a user interface.

15. The storage medium of claim 14, wherein the instructions, when executed by the hardware processor, further cause the IT operations management platform to generate data representing a workload layer of the map, wherein the workload layer represents a workflow of the microservices.

16. The storage medium of claim 15, wherein the instructions, when executed by the hardware processor, further cause the IT operations management platform to generate data representing association of the microservices with a plurality of instances and further representing associations of the plurality of instances with worker nodes of the container environment layer.

17. The storage medium of claim 16, wherein the instructions, when executed by the hardware processor, further cause the IT operations management platform to generate data representing associations of the worker node with virtual machines of the virtualization layer.

18. A method comprising:
communicating, by a processor-based operations management agent and with first collector agents of a container environment layer of a service stack of an application, to acquire first data representing resource associations of components of the container environment layer, wherein a plurality of microservices of the application are deployed on a distributed system;
communicating, by the processor-based operations management agent, with second collector agents of a virtualization layer of the service stack to acquire second data representing resource associations of components of the virtualization layer;
communicating, by the processor-based operations management agent, with third collector agents of an infrastructure layer of the service stack to acquire third data representing resource associations of components of the infrastructure layer; and
generating, by the processor-based operations management agent, fourth data to display a service stack map on a graphical user interface based on the first data, the second data and the third data.

19. The method of claim 18, wherein:
the microservices are associated with instances corresponding to container pods of the container environment layer;
the container pods are associated with worker nodes of the container environment layer; and
communicating with the first collector agents comprises communicating with agents of the worker nodes.

20. The method of claim 18, wherein:
the worker nodes are deployed on virtual machines of the virtualization layer; and
communicating with the second collector agents comprises communicating with guest operating system kernels of the virtual machines.
